(19) United States
(12) Patent Application Publication
(10) Pub. No.: US 2025/0370839 A1
(43) Pub. Date: Dec. 4, 2025

(54) SOFTWARE APPLICATION TESTING WITH FLAKY TEST CASE DETECTION

(71) Applicant: SAP SE, Walldorf (DE)

(72) Inventors: Jingun Hong, Seongnam-si (KR); Thomas Bach, Rauenberg (DE); Gabin An, Daejeon (KR); Juyeon Yoon, Daejeon (KR)

(21) Appl. No.: 18/678,587

(22) Filed: May 30, 2024

(51) Int. Cl. G06F 11/07; G06F 11/36

(52) U.S. Cl. CPC G06F 11/0766; G06F 11/3636; G06F 11/3684; G06F 11/3688

(57) ABSTRACT

Various examples are directed to systems and methods for debugging a software application. A computing system may access first stack trace data describing a plurality of function calls made by a software application during a failed execution of a first test case. The computing system may compare the first stack trace data and flaky test case data. The flaky test case data may describe at least one function call made by the software application during execution of at least one flaky test case. The at least one flaky test case may comprise a first flaky test case that the software application passed during one execution of the first flaky test case and failed during another execution of the first flaky test case. Based at least in part on the comparing, the computing system may determine that the first test case is a flaky test case.

### BACKGROUND

Traditional modes of software development involve developing a software application and then performing error detection and debugging on the application before it is released to customers and/or other users. Error detection and debugging were time-consuming, largely manual activities. Because releases were typically separated in time by several months or even years, however, smart project planning could leave sufficient time and resources for adequate error detection and debugging.

### BRIEF DESCRIPTION OF DRAWINGS

The present disclosure is illustrated by way of example and not limitation in the following figures.

FIG. 1 is a diagram showing one example of an environment for software testing.

FIG. 2 is a diagram showing one example of a CI/CD pipeline incorporating various software testing described herein.

FIG. 3 is a flowchart showing one example of a process flow that may be executed in the environment of FIG. 1 to determine whether a failed test case is flaky.

FIG. 4 is a flowchart showing one example of a process flow that may be executed in the environment of FIG. 1 to perform a comparison between stack trace data and/or error message data describing a failed test case and flaky test case data.

FIG. 5 is a flowchart showing another example of a process flow that may be executed in the environment of FIG. 1 to perform a comparison between stack trace data and/or error message data describing a failed test case and flaky test case data.

FIG. 6 is a block diagram showing one example of a software architecture for a computing device.

FIG. 7 is a block diagram of a machine in the example form of a computer system within which instructions may be executed for causing the machine to perform any one or more of the methodologies discussed herein.

### DETAILED DESCRIPTION

Various examples described herein are directed to software testing and error detection with flaky test case detection.

In many software delivery environments, modifications to a software application are coded, tested, and sometimes released to users on a fast-paced timescale, sometimes quarterly, bi-weekly, or even daily. Also, large-scale software applications may be serviced by a large number of software developers, with many developers and developer teams making modifications to the software application.

In some example arrangements, a continuous integration/continuous delivery (CI/CD) pipeline arrangement is used to support a software application. According to CI/CD pipeline, a developer entity maintains an integrated source of an application, called a mainline or mainline build. The mainline build is the most recent build of the software application that has passed all testing. At release time, the mainline build is released to and may be installed at various production environments such as, for example, at public cloud environments, private cloud environments, and/or on-premise computing systems where users can access and utilize the software application.

Between releases, a development team or teams may work to update and maintain the software application. When it is desirable for a developer to make a change to the application, the developer checks out a version of the mainline build from a source code management (SCM) system into a local developer repository. The developer builds and tests modifications to the mainline. When the modifications are completed and tested, the developer initiates a commit operation. In the commit operation, the CI/CD pipeline executes an additional series of integration and acceptance tests to generate a new mainline build that includes the developer's modifications. In some examples, the developer may also initiate pre-submit testing. According to pre-submit testing, a commit operation and new build are generated and subjected to testing without the new build replacing all or part of the previous mainline build. Pre-submit testing may be used, for example, to allow developers to test modifications to the software application between updates to the mainline build.

Applying the various integration and acceptance tests may comprise applying one or more test cases to a new build. A test case may comprise input data describing a set of input parameters provided to a build and result data describing how the build is expected to behave when provided with the set of input parameters. Executing a test case may comprise providing the set of input parameters to the build and observing how it responds. For example, a build may pass the test case if it generates an output that is equivalent to the result data. On the other hand, if the build crashes, resulting in a crash failure, or generates incorrect output, this may be considered a failure of the test case.

When a new build suffers a failure of at least one test case, a corrective action may be performed. The corrective action may include restoring a previous version of the build to prevent the potentially erroneous new build from reaching production. The corrective action may also include referring the new build to a developer user to identify and correct any errors in the build that may have caused the test case failure or failures.

In some examples, a test case may be flaky. A flaky test case is a test case that fails a software application (e.g., a particular build thereof) on at least one execution of the test case and also passes the software application (e.g., the same build thereof) on at least one different execution of the test case. A developer tasked with debugging or otherwise testing the software application may treat a test case failure differently if the failed test case is flaky. For example, when a software application (a build thereof) fails a test case that is not flaky, it may indicate that there is a bug or other error in the software application and a corrective action may be instituted to fix the bug or other error. When a software application fails a flaky test case, however, the failure may not be indicative of any error or bug in the software application itself. The failure of a flaky test case, then, may indicate an error or bug in the software application, an error or bug in the testing system, or other issue. In some examples, developers may ignore failures of flaky test cases and/or may treat failures of flaky test cases differently than failures of non-flaky test cases. Accordingly, in some examples, it is desirable to identify flaky test cases.

In various examples, a testing system can be configured to detect flaky test cases by rerunning failed test cases. This may include rerunning all failed test cases multiple times. In some systems, each failed test case is rerun three times, bringing the total number of executions for each failed test case to four. In other examples, failed test cases are rerun more or fewer than three times. After rerunning a test case, the testing system determines whether any of the rerun executions of the test case have passed the software application. If at least one of the rerun executions of the test case has passed the software application, then the testing system may determine that the test case is flaky. An indication that the test case is flaky may be provided to one or more developers, for example, along with results of one or more other test case executions. The developer, in some examples, may ignore test case results from flaky test cases and/or may allocate resources away from flaky test cases and towards test case failures that are not flaky.

Rerunning every failed test case, however, can consume considerable computing resources including, processor resources, memory resources, network resources, and/or the like. Computing resource usage, for example, may be particularly burdensome for pre-submit builds. A pre-submit build may be subjected to a suite of test cases before the build is incorporated into the mainline of the software application. Developers may utilize pre-submit testing (e.g., testing of pre-submit builds) to identify bugs and other errors in a build of the software application before attempting to incorporate the new build into the mainline of the software application. Accordingly, pre-submit testing may occur at a higher frequency. As a result, the computing resources consumed to rerun failed test cases for pre-submit builds can substantially add to the total computing resources utilized for rerunning failed test cases.

Various examples described herein address these and other challenges utilizing flaky test case detection based on flaky test case properties. Flaky test case properties may include, for example, functions called by the software application during execution of the test case, error messages generated by the software application during execution of the test case, and/or the like. A testing system may access stack trace data describing function calls made by a software application during a failed execution of a first test case. The testing system may also access flaky test case data. The flaky test case data may identify properties of test cases that are known to be flaky. The testing system may compare the stack trace data from the failure of the first test case to the flaky test case data. If a match is found, the testing system may determine that the first test case is a flaky test case. The testing system may write an indication that the first test case is flaky to a data store. The indication may also be provided to a developer user. In this way, developer user resources may be more efficiently allocated. For example, developer user resources may be preferentially directed to failed test cases that are not flaky.

In some examples, if comparison to the flaky test case data does not indicate that the first test case is flaky, the testing system may rerun the first test case a number of tops (e.g., two times, three times, and/or the like). If the first test case fails the software application in each of the then the testing system may determine that the first test case is not a flaky test case and may deal with it accordingly. For example, the testing system may prompt a corrective action based on the first test case. On the other hand, if the first test case passes at least one execution of the rerun, then the testing system may determine that the first test case is flaky. When the testing system determines that a test case is flaky after rerunning the test case, it may utilize the test case to update the flaky test case data applied to subsequently failed test cases.

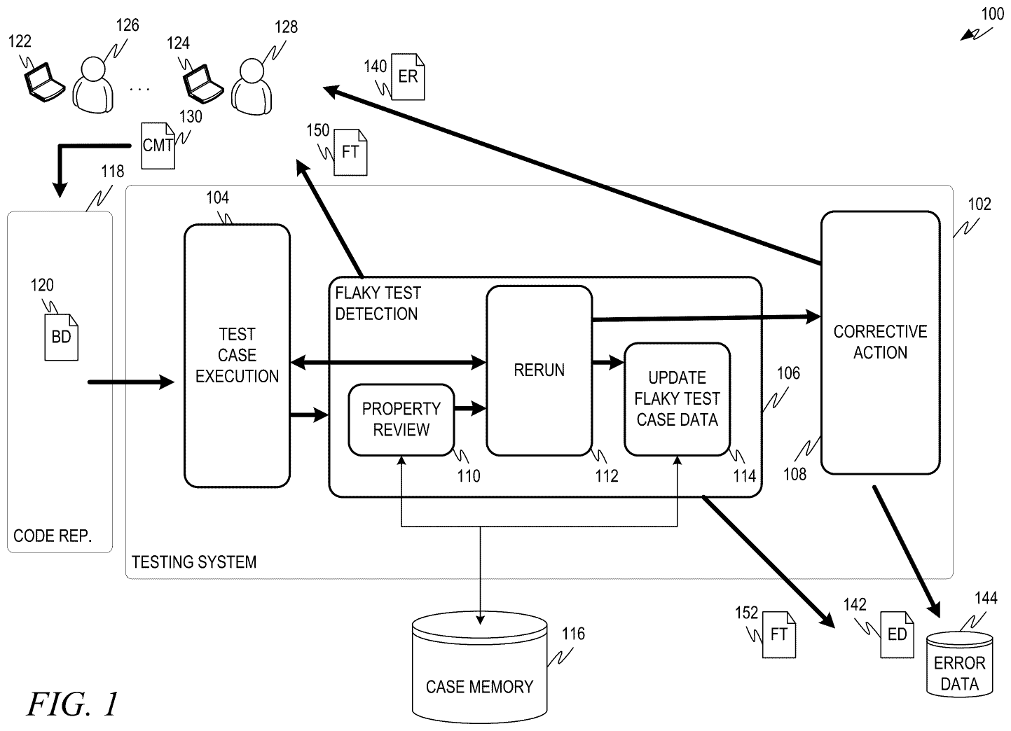

FIG. 1 is a diagram showing one example of an environment 100 for software testing. The environment 100 comprises a testing system 102 and a code repository 118, which may be all or part of an SCM system. The testing system 102 may include one or more computing devices that may be located at a single geographic location and/or distributed across different geographic locations.

One or more developer users 126, 128 may generate commit operations, such as commit operation 130. Developer users 126, 128 may utilize user computing devices 122, 124. User computing devices 122, 124 may be or include any suitable computing device such as, for example, desktop computers, laptop computers, tablet computers, mobile computing devices, and/or the like. For example, one or more of the developer users 126, 128 may check out a mainline of a software application from a code repository 118, which may be part of an SCM. The commit operation 130 may include changes to the previous mainline build. The commit operation 130 may result in a new build 120. In some examples, the new build 120 is subjected to pre-submit testing before it is submitted for incorporation into and/or replacement of the previous mainline. As described herein, this pre-submit testing can be initiated by the developer users 126, 128 as they develop the software application. In some examples, developer users 126, 128 will not submit a new build 120 for incorporation into and/or replacement of the previous mainline until it has passed pre-submit testing. Also, in some examples, submission of a new build 120 may happen periodically, such as for example, once a day, twice a day, every other day, and/or the like. New builds generated between periodic submissions may be subjected to pre-submit testing.

The testing system 102 may perform integration and acceptance tests on the changes implemented by the new build 120. The testing system 102 may comprise a test case execution system 104 for executing test cases, a flaky test detection system 106 for detecting flaky test cases, and a corrective action system 108. The various systems 104, 106, 108 may be implemented using various hardware and/or software subcomponents of the testing system 102. In some examples, one or more of the systems 104, 106, 108 is implemented on a discrete computing device or set of computing devices.

The testing system 102 is configured to test the new build 120 by applying one or more test cases. A test case may comprise input data describing a set of input parameters provided to a build and result data describing how the build is expected to behave when provided with the set of input parameters. The test case execution system 104 may apply a test case to the new build 120 by executing the new build 120, applying the test parameters to the new build 120, and observing the response of the new build 120. The new build 120 may pass the test case if it responds to the input data in the way described by the result data. If a build fails to respond to the input data in the way described by the result data, the build may fail the test case. For example, if the new build 120 crashes during a test case, it may not respond to the input data in the way described by the result data.

Consider an example in which the new build 120 is or includes a database management application. Test case data may comprise a set of one or more queries to be executed by the database management application and result data describing how the database management application should behave in response to the queries. The new build 120 may pass the test case if it generates the expected result data in response to the provided queries. Conversely, the new build 120 may fail the test case if it crashes or generates result data that is different than the expected result data.

During pre-submit testing, results of the test cases may be provided to one or more of the developer users 126, 128. In this way, the developer users 126, 128 may make modifications to be incorporated into later builds. During submission testing, results of the test cases may determine whether the new build 120 is deployed to supplement and/or replace the existing mainline build. For example, if the new build 120 passes all test cases, then it may be deployed as a new mainline build. If the new build 120 fails one or more test cases, it may not be deployed to supplement and/or replace the existing mainline build of the software application.

When the new build 120 fails one or more test cases, the test case execution system 104 may generate data describing the failed test case. The data may include, for example, stack trace data and error message data. Stack trace data describes function calls made by the software application during execution of a failed test case. For example, the stack trace data may include function names, line numbers, file names, source code lines, and or like data for each function called during execution of the test case. Error message data includes error message is generated by the software application during execution of the test case.

When a new build fails one or more test cases, the flaky test detection system 106 may be used to determine if the failed test case is flaky. The flaky test detection system 106 may comprise a property review system 110, a rerun system 112, and an update flaky test case data system 114. For a failed test case, the property review system 110 may access stack trace data and/or error message data. For example, this data may be received from the test case execution system 104. In some examples, the property review system 110 may perform filtering on the stack trace data and/or error message data. Filtering may include, for example, stack trace purification and/or number masking.

Stack trace purification may include modifying raw stack trace data to remove information that is not relevant to whether the test case is flaky. This may include, purifying the raw stack trace data to include information that captures the dynamic flow of the test case execution. In some examples, this includes modifying file and function names indicated by the stack trace data to refer to include regular expressions, for example, while removing less relevant information such as, for example, line numbers, source code style changes, and/or the like. Also, in some examples, function calls that are not relevant to the dynamic flow of the test case execution are removed. Such function calls could include, for example, function calls to initiate the testing process. The result of stack trace purification may be stack trace data that includes a sequence of file and function pairs, where each file and function pair indicates a function call made by the software application during execution of the failed test case.

Number masking may involve removing dynamic parts of the error message data and/or stack trace data. For example, the error message data and/or stack trace data may include dynamic information such as, IP addresses, dates, memory addresses, and/or the like. While this dynamic information may be useful in troubleshooting a particular error, it may not necessarily be common across multiple flaky test cases. Accordingly, number masking may include removing all numeric values in the error message data and/or stack trace data with a nonce character, such as “#.” In this way, the presence of the numbers is noted, but the particular value of the numbers may not be included.

The property review system 110 may also access flaky test case data, which may be stored at a case memory data store 116. The flaky test case data identifies properties of the test case failures that are known to be flaky. For example, the flaky test case data may include stack trace data generated during one or more flaky test case failures and/or error message data generated during one or more flaky test case failures. In some examples, the flaky test case data may have had stack trace data purification and number masking performed. The property review system 110 compares the stack trace data and/or error message data from the failed test case to the flaky test case data. Based on the comparison, the property review system 110 may determine whether the failed test case is flaky.

The property review system 110 may determine whether the failed test case is flaky based on any suitable criteria. In some examples, the property review system 110 counts a number of flaky properties for the failed test case. A flaky property of the failed test case may be a function call indicated by the stack trace data that is equivalent to a function call made by one or more known-flaky test cases described by the flaky test case data. In some examples, a flaky property of the failed test case may also be an error message of the error message data that is equivalent to an error message associated with one or more known-flaky test cases described by the flaky test case data. In some examples, two function calls may be equivalent if they call the same function, for example, using the same file. Two error messages may be equivalent if the error messages are of the same type and/or indicate the same error. The total number of flaky properties for the failed test case may be compared to a threshold. If the threshold is met, then the property review system 110 determines that the failed test case is a flaky test case.

Also, in some examples, the property review system 110 counts a number of common properties between the failed test cases and respective known-flaky test cases described by the flaky test data. The failed test case and a known-flaky test case described by the flakey test case data may have a common property, for example, if the failed test case and the non-flaky test case have a same error message and/or a same function call in common. If the number of common properties between the failed test case and at least one of the known-flaky test cases meets a threshold, then the property review system 110 determines that the failed test case is a flaky test case.

In some examples, the property review system 110 may apply different threshold for different types of properties. For example, the property review system 110 may apply a function threshold to functions from the stack trace data and an error message threshold to common error messages from the error message data. The property review system 110 may determine that a failed test case is flaky if the function threshold and/or error threshold is met (e.g., with respect to any one of the known-flaky test cases and/or for flaky properties of the failed test case).

If the property review system 110 fails to determine that the failed test case is flaky, it may indicate that the failed test case is not flaky, or that the failed test case is flaky but is not similar to previous known-flaky test cases described by the flaky test case data. Accordingly, if the property review system 110 fails to determine that a failed test case is flaky, the flaky test detection system 106 (e.g. the rerun system 112 thereof) may rerun the failed test case. This may include, for example, running a number of additional executions of the test case. In some examples, the rerun system 112 may prompt the test case execution system 104 rerun the number of additional executions of the test case. If the software application fails all of the additional executions, then the flaky test detection system 106 (e.g. the rerun system 112 thereof) may initiate a corrective action, for example, by providing an indication of the test case to the corrective action system 108.

If the software application passes at least one of the additional executions, then the test case may be flaky. In response, the test detection system 106 (e.g. the update flaky test case data system 114) may update the flaky test case data stored at the case memory data store 116. This may include, for example, a pending stack trace data and/or error message data for the test case to the stack trace data and/or error message data for the known-flaky test cases described by the flaky test case data.

If the flaky test detection system 106, determines that a failed test case is flaky, either by comparison to the flaky test data at the property review system 110, or if the failed test case passes a subsequent rerun execution, it may provide an indication to a user that the failed test case is flaky. For example, the flaky test detection system 106 may provide a flaky test message 150 one or more of the developer users 126, 128. In some examples, the flaky test message 150 is provided to the developer user 126, 128 who made the commit operation 130 to create the new build 120 and/or to a different developer user 126, 128. In addition to or instead of providing the flaky test message 150, the flaky test detection system 106 may write flaky test indicator data 152 indicating that a failed test is flaky to an error data store 144, where it may be used by the developer users 126, 128 for debugging or otherwise correcting the software application. For example, developer users 126, 128 may utilize the flaky test indicator data 152 to allocate developer resources for analyzing failed test cases and making corrections to the software application.

The corrective action system 108 may execute one or more corrective actions when a new build 120 fails a test case and the flaky test detection system 106 determines that the failed test case is not flaky. In some examples, the corrective action system 108 sends a report message 140 to one or more developer users 126, 128. The report message 140 may comprise an indication of the commit operation 130 and/or the new build 120. In some examples, the report message 140 includes or describes the stack trace data of one or more crash failures of the new build 120 during the application of test cases. For example, the report message 140 may provide an indication of a component or other portion of the software application that is associated with each function call in the stack trace data or stack trace data.

The report message 140 may also provide an indication of whether any crash failures of the new build 120 are duplicates of one another and/or duplicates of known errors in the software application. In some examples, the corrective action system 108 routes the report message 140 to the developer user 126, 128 that submitted the error-inducing commit operation or to a different developer user 126, 128.

In some examples, the corrective action system 108 stores error data 142 at an error data store 144. The error data 142 describes the commit operation 130 and/or new build 120 that failed at least one test case. In some examples, the error data 142 also describes one or more report messages 140 provided to one or more developer users 126, 128 for correcting the commit operation 130.

Another example corrective action that may be taken by the corrective action system 108 includes reverting the software application to a good build. A good build may be a build that was generated by a commit operation prior to the commit operation 130. In some examples, the good build is the build generated by the commit operation immediately before the error-inducing commit operation 130.

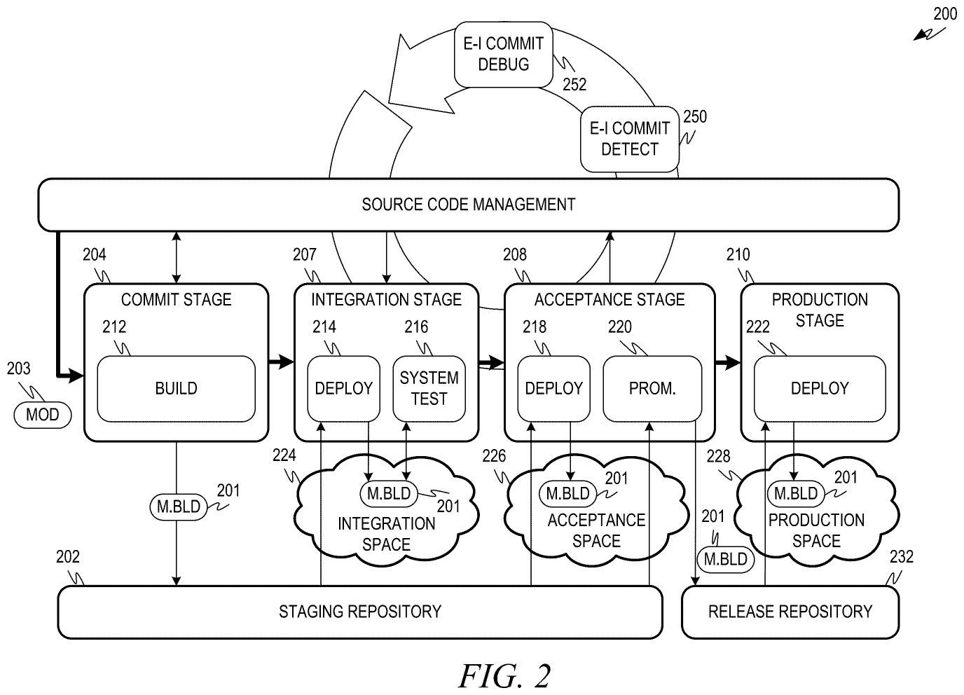

FIG. 2 is a diagram showing one example of a CI/CD pipeline 200 incorporating various software testing described herein. The CI/CD pipeline 200 is initiated when a developer user, such as one of developer users 126, 128, submits a build modification 203 to the commit stage 204, initiating a commit operation. The build modification 203 may include a modified version of the mainline build previously downloaded by the developer user 126, 128.

The commit stage 204 executes a commit operation 212 to create and/or refine the modified software application build 201. For example, the mainline may have changed since the time that the developer user 126, 128 downloaded the mainline version used to create the build modification 203. The modified software application build 201 generated by commit operation 212 includes the changes implemented by the modification 203 as well as any intervening changes to the mainline. The commit operation 212 and/or commit stage 204 stores the modified software application build 201 to a staging repository 202 where it can be accessed by various other stages of the CI/CD pipeline 200.

An integration stage 207 receives the modified software application build 201 for further testing. A deploy function 214 of the integration stage 207 deploys the modified software application build 201 to an integration space 224. The integration space 224 is a test environment to which the modified software application build 201 can be deployed for testing. While the modified software application build 201 is deployed at the integration space 224, a system test function 216 performs one or more integration tests on the modified software application build 201. In some examples, the testing system 102 of FIG. 1 may be utilized to perform all or part of the system test function 216. If the modified software application build 201 fails one or more of the test cases, it may be returned to the developer user 126, 128 for correction. If the modified software application build 201 passes testing, the integration stage 207 provides an indication indicating the passed testing to an acceptance stage 208.

The acceptance stage 208 uses a deploy function 218 to deploy the modified software application build 201 to an acceptance space 226. The acceptance space 226 is a test environment to which the modified software application build 201 can be deployed for testing. While the modified software application build 201 is deployed at the acceptance space 226, a promotion function 220 applies one or more promotion tests to determine whether the modified software application build 201 is suitable for deployment to a production environment. Example acceptance tests that may be applied by the promotion function 220 include Newman tests, UiVeri5 tests, Gauge BDD tests, various security tests, etc. If the modified software application build 201 fails the testing, it may be returned to the developer user 126, 128 for correction. If the modified software application build 201 passes the testing, the promotion function 220 may write the modified software application build 201 to a release repository 232, from which it may be deployed to production environments.

The example of FIG. 2 shows a single production stage 210. The production stage 210 includes a deploy function 222 that reads the modified software application build 201 from the release repository 232 and deploys the modified software application build 201 to a production space 228. The production space 228 may be any suitable production space or environment as described herein.

The various examples for software testing described herein may be implemented during the acceptance stage 208 and/or the integration stage 207. An error-inducing detection operation 250 may be executed by the testing system 102 utilizing fault localization, as described herein. An error-inducing commit debug or correction operation 252 may be executed by the testing system 102 (e.g., the corrective action system 108) as described herein.

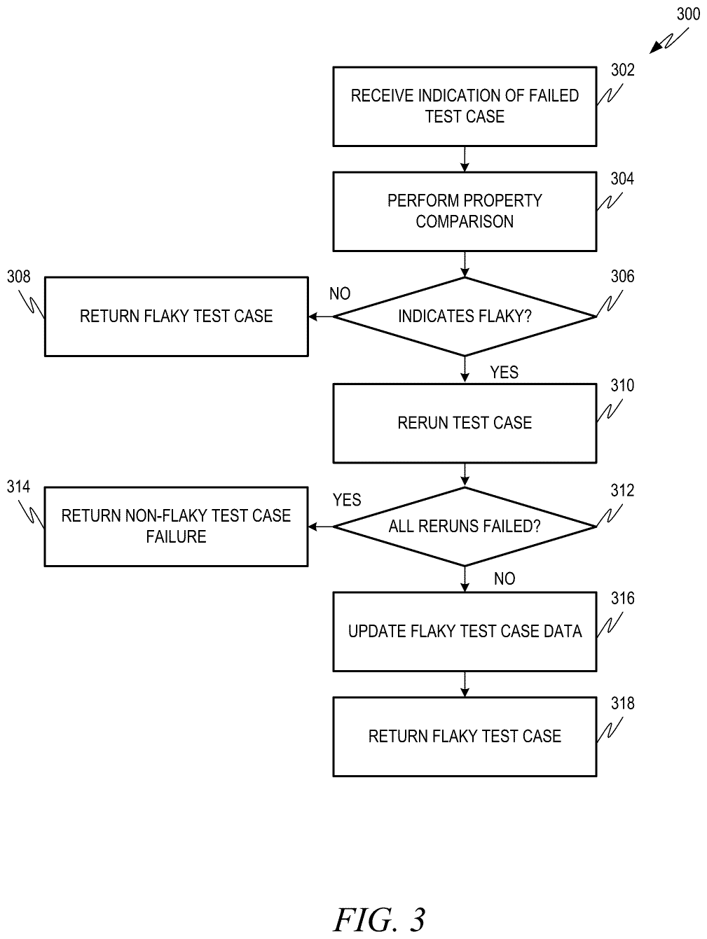

FIG. 3 is a flowchart showing one example of a process flow 300 that may be executed in the environment 100 of FIG. 1 to determine whether a failed test case is flaky. At operation 302, the flaky test detection system 106 may receive an indication of a failed test case. In some examples, the indication of the failed test case may be accompanied by a stack trace data and/or error message data describing execution of the failed test case.

At operation 304, the property review system 110 may compare the stack trace data and/or error message data for the failed test case to flaky test case data. Based on the comparison, the property review system 110 may determine, at operation 306, if the failed test case is a flaky test case. If the comparison indicates that the failed test case is a flaky test case, then the flaky test detection system 106 may, at operation 308, return an indication that the failed test case is a flaky test case. This may include, for example, providing a failed test case message 150 to one or more developer users 126, 128 and/or writing flaky test case indicator data 152 describing the failed test case to the error data store 144.

If the comparison does not indicate that the failed test case is flaky, then the flaky test detection system 106 may rerun or initiate the rerunning of multiple additional executions of the test case at operation 310. If the flaky test detection system 106, at operation 312, that the software application failed all of the rerun executions of the test case, then it may return, at operation 314, an indication that the failed test case is not a flaky test case. For example, the corrective action system 108 may be prompted to execute a corrective action, for example, as described herein.

If the software application passes at least one of the rerun test case executions, then the flaky test case system 106 may update the flaky test case data at operation 316 and return an indication that the failed test cases flaky at operation 318.

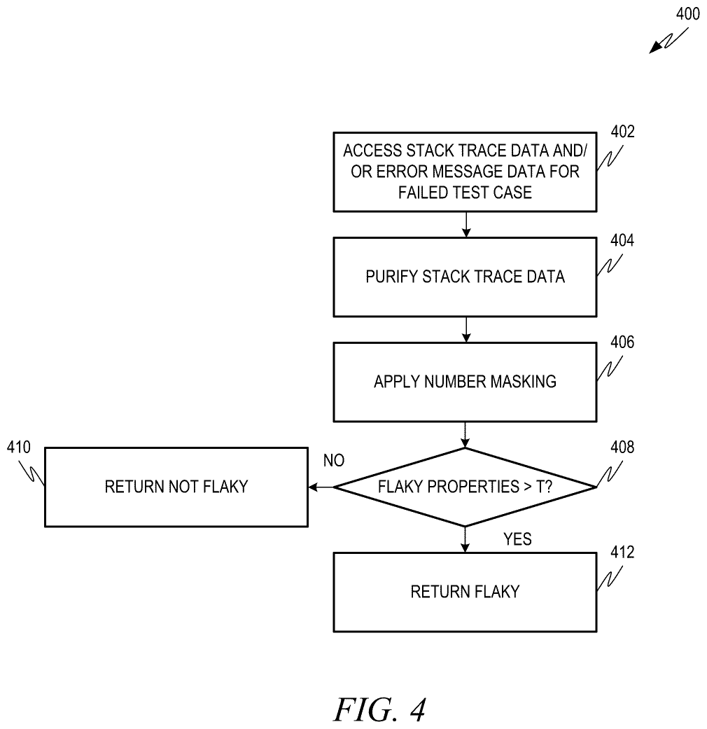

FIG. 4 is a flowchart showing one example of a process flow 400 that may be executed in the environment 100 of FIG. 1 to perform a comparison between stack trace data and/or error message data describing a failed test case and flaky test case data. For example, the flowchart 400 shows one example way for performing operation 304 of the process flow 300.

At operation 402, the flaky test detection system 106 may access stack trace data and/or error message data for a failed test case. In some examples, the stack trace data and/or error message data for the failed test case is provided by the test case execution system 104. At operation 404, the flaky test detection system 106 may purify the stack trace data. This may include, for example, removing from the raw stack trace data information such as, for example, line numbers, source code styled changes, and/or the like. At operation 406, the flaky test detection system 106 may apply number masking to the error as described herein, replacing numeric values with nonce characters.

At operation 408, the flaky test detection system 106 (e.g. the property review system 110 thereof) determines whether the number of flaky properties indicated by the stack trace data and/or error message data of the failed test case is greater than a threshold value. A flaky property may be indicated by the stack trace data, for example, if a function call indicated by the stack trace data match is a function call made by one or more known-flaky test cases described by the flaky test case data. A flaky property may be indicated by the error message data if an error message described by the error message data matches and error message returned by one or more known-flaky test cases described by the flaky test case data.

If the total number of flaky properties meets the threshold, then the flaky test detection system 106 may, at operation 412, return an indication that the failed test cases flaky. If the total number of flaky properties does not meet the threshold, then the flaky test detection system 106 may, at operation 410, return that the failed test case is not indicated to be flaky by the flaky test case data comparison. This may prompt the flaky test detection system 106 to initiate reruns of the test case, as described herein.

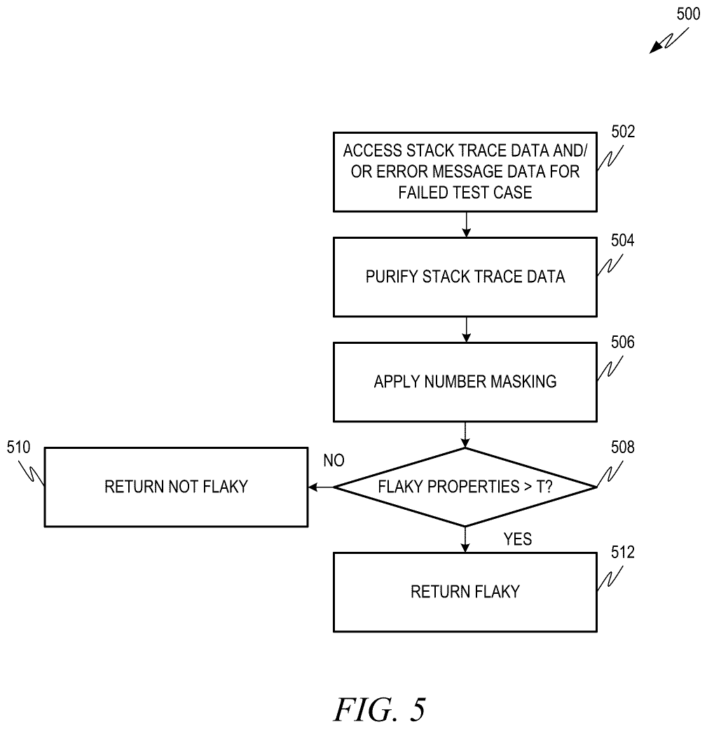

FIG. 5 is a flowchart showing another example of a process flow 500 that may be executed in the environment 100 of FIG. 1 to perform a comparison between stack trace data and/or error message data describing a failed test case and flaky test case data. For example, the flowchart 500 shows one example way for performing operation 304 of the process flow 300.

At operation 502, the flaky test detection system 106 may access stack trace data and/or error message data for a failed test case. In some examples, the stack trace data and/or error message data for the failed test case is provided by the test case execution system 104. At operation 504, the flaky test detection system 106 may purify the stack trace data. This may include, for example, removing from the raw stack trace data information such as, for example, line numbers, source code styled changes, and/or the like. At operation 506, the flaky test detection system 106 may apply number masking to the error as described herein, replacing numbers with nonce characters.

At operation 508, the flaky test detection system 106 (e.g. the property review system 110 thereof) determines whether the stack trace data and/or error state data includes a threshold number of common properties with at least one flaky test case described by the flaky test data. If the stack trace data and/or error state data does include a threshold number of common properties with at least one flaky test case described by the flaky test case data, then the flaky test detection system 106 may, at operation 512, return an indication that the failed test cases flaky. If the stack trace data and/or error state data does include a threshold number of common properties with at least one flaky test case described by the flaky test case data, then the flaky test detection system 106 may, at operation 510, return that the failed test case is not indicated to be flaky by the flaky test case data comparison. This may prompt the flaky test detection system 106 to initiate reruns of the test case, as described herein.

In view of the disclosure above, various examples are set forth below. It should be noted that one or more features of an example, taken in isolation or combination, should be considered within the disclosure of this application.

### EXAMPLES

Example 1 is a system for debugging a software application, comprising: at least one processor programmed to perform operations comprising: accessing first stack trace data, the first stack trace data describing a plurality of function calls made by the software application during a failed execution of a first test case; comparing the first stack trace data and flaky test case data, the flaky test case data describing at least one function call made by the software application during execution of at least one flaky test case, the at least one flaky test case comprising a first flaky test case that the software application passed during one execution of the first flaky test case and failed during another execution of the first flaky test case; based at least in part on the comparing, determining that the first test case is a flaky test case; and providing, to a user, an indication that the first test case is a flaky test case.

In Example 2, the subject matter of Example 1 optionally includes the operations further comprising: accessing second stack trace data, the second stack trace data describing a plurality of function calls made by the software application during a failed execution of a second test case; comparing the second stack trace data to flaky test case data; determining that the comparing does not indicate that the second test case is a flaky test case; performing a set of additional executions of the second test case; determining that the software application passed at least one of the set of additional executions of the second test case; and updating the flaky test case data based at least in part on the second stack trace data.

In Example 3, the subject matter of any one or more of Examples 1-2 optionally includes the operations further comprising: accessing first error message data describing the failed execution of the first test case; and comparing the first error message data and the flaky test case data, the determining that the first test case is a flaky test case also being based at least in part on the comparing of the first error message data and the flaky test case data.

In Example 4, the subject matter of any one or more of Examples 1-3 optionally includes the flaky test case data describing a plurality of function calls made by the software application during execution of the at least one flaky test case, the determining that the first test case is a flaky test case comprising determining that a number of common function calls described by both the first stack trace data and the flaky test case data meets a threshold.

In Example 5, the subject matter of any one or more of Examples 1-4 optionally includes the flaky test case data describing a plurality of function calls made by the software application during execution of the at least one flaky test case, the determining that the first test case is a flaky test case comprising determining that the plurality of function calls made by the software application during the failed execution of the first test case were also made by a threshold number of the at least one flaky test case.

In Example 6, the subject matter of any one or more of Examples 1-5 optionally includes the determining that the first test case is a flaky test case further comprising determining that a threshold number of error messages described by first error message data describing the failed execution of the first test case match at least one error message described by the flaky test case data.

In Example 7, the subject matter of any one or more of Examples 1-6 optionally includes the operations further comprising, before the comparing, filtering the first stack trace data to remove at least a portion of the plurality of function calls.

In Example 8, the subject matter of Example 7 optionally includes the at least a portion of the plurality of function calls comprising at least one function call not associated with the first test case.

In Example 9, the subject matter of any one or more of Examples 1-8 optionally includes the operations further comprising, before the comparing, removing at least a portion of numerical values of the first stack trace data.

Example 10 is a method of debugging a software application, comprising: accessing first stack trace data, the first stack trace data describing a plurality of function calls made by the software application during a failed execution of a first test case; comparing the first stack trace data and flaky test case data, the flaky test case data describing at least one function call made by the software application during execution of at least one flaky test case, the at least one flaky test case comprising a first flaky test case that the software application passed during one execution of the first flaky test case and failed during another execution of the first flaky test case; based at least in part on the comparing, determining that the first test case is a flaky test case; and providing, to a user, an indication that the first test case is a flaky test case.

In Example 11, the subject matter of Example 10 optionally includes accessing second stack trace data, the second stack trace data describing a plurality of function calls made by the software application during a failed execution of a second test case; comparing the second stack trace data to flaky test case data; determining that the comparing does not indicate that the second test case is a flaky test case; performing a set of additional executions of the second test case; determining that the software application passed at least one of the set of additional executions of the second test case; and updating the flaky test case data based at least in part on the second stack trace data.

In Example 12, the subject matter of any one or more of Examples 10-11 optionally includes accessing first error message data describing the failed execution of the first test case; and comparing the first error message data and the flaky test case data, the determining that the first test case is a flaky test case also being based at least in part on the comparing of the first error message data and the flaky test case data.

In Example 13, the subject matter of any one or more of Examples 10-12 optionally includes the flaky test case data describing a plurality of function calls made by the software application during execution of the at least one flaky test case, the determining that the first test case is a flaky test case comprising determining that a number of common function calls described by both the first stack trace data and the flaky test case data meets a threshold.

In Example 14, the subject matter of any one or more of Examples 10-13 optionally includes the flaky test case data describing a plurality of function calls made by the software application during execution of the at least one flaky test case, the determining that the first test case is a flaky test case comprising determining that the plurality of function calls made by the software application during the failed execution of the first test case were also made by a threshold number of the at least one flaky test case.

In Example 15, the subject matter of any one or more of Examples 10-14 optionally includes the determining that the first test case is a flaky test case further comprising determining that a threshold number of error messages described by first error message data describing the failed execution of the first test case match at least one error message described by the flaky test case data.

In Example 16, the subject matter of any one or more of Examples 10-15 optionally includes before the comparing, filtering the first stack trace data to remove at least a portion of the plurality of function calls.

In Example 17, the subject matter of Example 16 optionally includes the at least a portion of the plurality of function calls comprising at least one function call not associated with the first test case.

In Example 18, the subject matter of any one or more of Examples 10-17 optionally includes before the comparing, removing at least a portion of numerical values of the first stack trace data.

Example 19 is a non-transitory machine-readable medium comprising instructions thereon that, when executed by at least one processor, because the at least one processor to perform operations: accessing first stack trace data, the first stack trace data describing a plurality of function calls made by a software application during a failed execution of a first test case; comparing the first stack trace data and flaky test case data, the flaky test case data describing at least one function call made by the software application during execution of at least one flaky test case, the at least one flaky test case comprising a first flaky test case that the software application passed during one execution of the first flaky test case and failed during another execution of the first flaky test case; based at least in part on the comparing, determining that the first test case is a flaky test case; and providing, to a user, an indication that the first test case is a flaky test case.

In Example 20, the subject matter of Example 19 optionally includes accessing second stack trace data, the second stack trace data describing a plurality of function calls made by the software application during a failed execution of a second test case; comparing the second stack trace data to flaky test case data; determining that the comparing does not indicate that the second test case is a flaky test case; performing a set of additional executions of the second test case; determining that the software application passed at least one of the set of additional executions of the second test case; and updating the flaky test case data based at least in part on the second stack trace data.

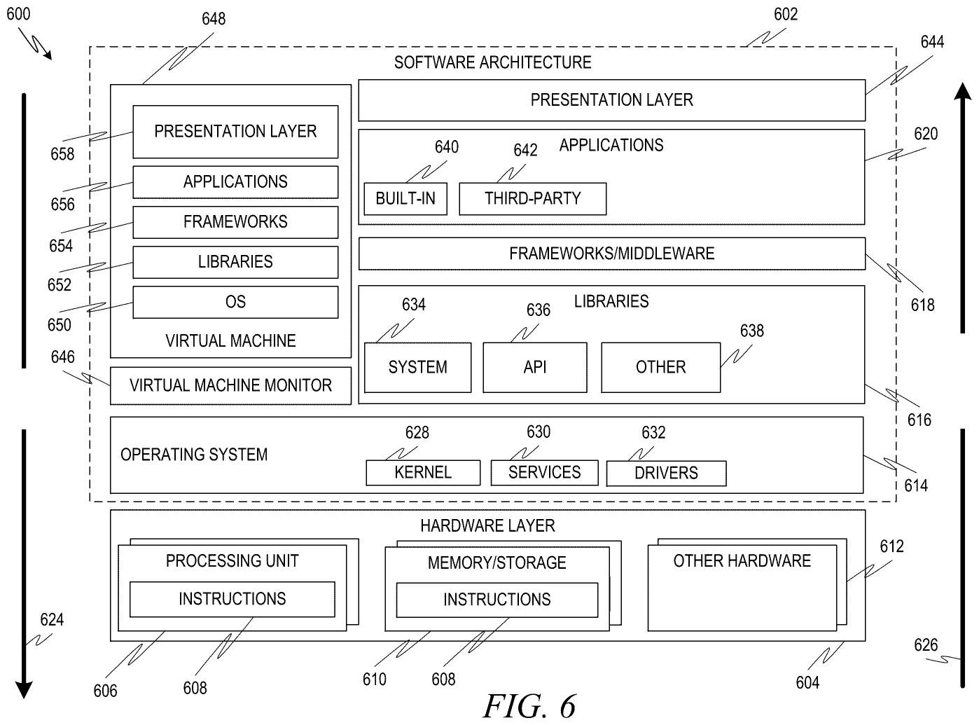

FIG. 6 is a block diagram 600 showing one example of a software architecture 602 for a computing device. The software architecture 602 may be used in conjunction with various hardware architectures, for example, as described herein. FIG. 6 is merely a non-limiting example of a software architecture and many other architectures may be implemented to facilitate the functionality described herein. The software architecture 602 and various other components described in FIG. 6 may be used to implement various other systems described herein. For example, the software architecture 602 shows one example way for implementing a testing system 102 or other computing devices described herein.

In FIG. 6, a representative hardware layer 604 is illustrated and can represent, for example, any of the above referenced computing devices. In some examples, the hardware layer 604 may be implemented according to the architecture of the computer system of FIG. 6.

The representative hardware layer 604 comprises one or more processing units 606 having associated executable instructions 608. Executable instructions 608 represent the executable instructions of the software architecture 602, including implementation of the methods, modules, systems, and components, and so forth described herein and may also include memory and/or storage modules 610, which also have executable instructions 608. Hardware layer 604 may also comprise other hardware as indicated by other hardware 612 which represents any other hardware of the hardware layer 604, such as the other hardware illustrated as part of the software architecture 602.

In the example architecture of FIG. 6, the software architecture 602 may be conceptualized as a stack of layers where each layer provides particular functionality. For example, the software architecture 602 may include layers such as an operating system 614, libraries 616, middleware layer 618 (sometimes referred to as frameworks), applications 620, and presentation layer 644. Operationally, the applications 620 and/or other components within the layers may invoke API calls 624 through the software stack and access a response, returned values, and so forth illustrated as messages 626 in response to the API calls 624. The layers illustrated are representative in nature and not all software architectures have all layers. For example, some mobile or special purpose operating systems may not provide the middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of an interrupt and, in response, cause the software architecture 602 to pause its current processing and execute an interrupt service routine (ISR) when an interrupt is accessed.

The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and/or the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and/or the like. The libraries 616 may also include a wide variety of other libraries 638 to provide many other APIs to the applications 620 and other software components/modules.

The middleware layer 618 (also sometimes referred to as frameworks) may provide a higher-level common infrastructure that may be utilized by the applications 620 and/or other software components/modules. For example, the middleware layer 618 may provide various graphic user interface (GUI) functions, high-level resource management, high-level location services, and so forth. The middleware layer 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a contacts application, a browser application, a book reader application, a location application, a media application, a messaging application, and/or a game application. Third-party applications 642 may include any of the built-in applications 640 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 642 may invoke the API calls 624 provided by the mobile operating system, such as operating system 614, to facilitate functionality described herein.

The applications 620 may utilize built-in operating system functions (e.g., kernel 628, services 630 and/or drivers 632), libraries (e.g., system 634, API libraries 636, and other libraries 638), and middleware layer 618 to create user interfaces to interact with users of the system. Alternatively, or additionally, in some systems interactions with a user may occur through a presentation layer, such as presentation layer 644. In these systems, the application/module “logic” can be separated from the aspects of the application/module that interact with a user.

Some software architectures utilize virtual machines. For example, the various environments described herein may implement one or more virtual machines executing to provide a software application or service. The example of FIG. 6 illustrates by virtual machine 648. A virtual machine creates a software environment where applications/modules can execute as if they were executing on a hardware computing device. A virtual machine 648 is hosted by a host operating system (operating system 614) and typically, although not always, has a virtual machine monitor 646, which manages the operation of the virtual machine 648 as well as the interface with the host operating system (i.e., operating system 614). A software architecture executes within the virtual machine 648. The software architecture may be or include, for example, an operating system 650, libraries 652, frameworks/middleware 654, applications 656 and/or presentation layer 658. These layers of software architecture executing within the virtual machine 648 can be the same as corresponding layers previously described or may be different.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

Computer software, including code for implementing software services, can be written in any form of programming language, including compiled or interpreted languages, and it can be deployed in any form, including as a standalone program or as a module, subroutine, or other unit suitable for use in a computing environment. Computer software can be deployed to be executed on one computer or on multiple computers at one site or distributed across multiple sites and interconnected by a communication network.

In example embodiments, operations may be performed by one or more programmable processors executing a computer program to perform functions by operating on input data and generating output.

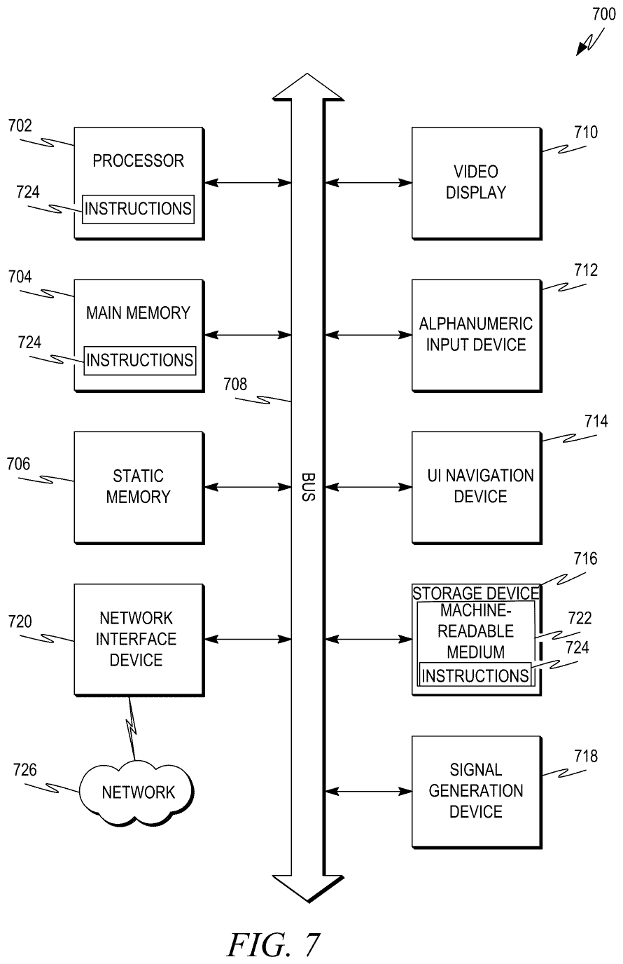

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation (or cursor control) device 714 (e.g., a mouse), a storage device 716, such as a disk drive unit, a signal generation device 718 (e.g., a speaker), and a network interface device 720.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media 722.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 724 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for debugging a software application, comprising:
at least one processor programmed to perform operations comprising:
accessing first stack trace data, the first stack trace data describing a plurality of function calls made by the software application during a failed execution of a first test case;
comparing the first stack trace data and flaky test case data, the flaky test case data describing at least one function call made by the software application during execution of at least one flaky test case, the at least one flaky test case comprising a first flaky test case that the software application passed during one execution of the first flaky test case and failed during another execution of the first flaky test case;
based at least in part on the comparing, determining that the first test case is a flaky test case; and
providing, to a user, an indication that the first test case is a flaky test case.

2. The system of claim 1, the operations further comprising:
accessing second stack trace data, the second stack trace data describing a plurality of function calls made by the software application during a failed execution of a second test case;
comparing the second stack trace data to flaky test case data;
determining that the comparing does not indicate that the second test case is a flaky test case;
performing a set of additional executions of the second test case;
determining that the software application passed at least one of the set of additional executions of the second test case; and
updating the flaky test case data based at least in part on the second stack trace data.

3. The system of claim 1, the operations further comprising:
accessing first error message data describing the failed execution of the first test case; and
comparing the first error message data and the flaky test case data, the determining that the first test case is a flaky test case also being based at least in part on the comparing of the first error message data and the flaky test case data.

4. The system of claim 1, the flaky test case data describing a plurality of function calls made by the software application during execution of the at least one flaky test case, the determining that the first test case is a flaky test case comprising determining that a number of common function calls described by both the first stack trace data and the flaky test case data meets a threshold.

5. The system of claim 1, the flaky test case data describing a plurality of function calls made by the software application during execution of the at least one flaky test case, the determining that the first test case is a flaky test case comprising determining that the plurality of function calls made by the software application during the failed execution of the first test case were also made by a threshold number of the at least one flaky test case.

6. The system of claim 1, the determining that the first test case is a flaky test case further comprising determining that a threshold number of error messages described by first error message data describing the failed execution of the first test case match at least one error message described by the flaky test case data.

7. The system of claim 1, the operations further comprising, before the comparing, filtering the first stack trace data to remove at least a portion of the plurality of function calls.

8. The system of claim 7, the at least a portion of the plurality of function calls comprising at least one function call not associated with the first test case.

9. The system of claim 1, the operations further comprising, before the comparing, removing at least a portion of numerical values of the first stack trace data.

10. A method of debugging a software application, comprising:
accessing first stack trace data, the first stack trace data describing a plurality of function calls made by the software application during a failed execution of a first test case;
comparing the first stack trace data and flaky test case data, the flaky test case data describing at least one function call made by the software application during execution of at least one flaky test case, the at least one flaky test case comprising a first flaky test case that the software application passed during one execution of the first flaky test case and failed during another execution of the first flaky test case;
based at least in part on the comparing, determining that the first test case is a flaky test case; and
providing, to a user, an indication that the first test case is a flaky test case.

11. The method of claim 10, further comprising:
accessing second stack trace data, the second stack trace data describing a plurality of function calls made by the software application during a failed execution of a second test case;
comparing the second stack trace data to flaky test case data;
determining that the comparing does not indicate that the second test case is a flaky test case;
performing a set of additional executions of the second test case;
determining that the software application passed at least one of the set of additional executions of the second test case; and
updating the flaky test case data based at least in part on the second stack trace data.

12. The method of claim 10, further comprising:
accessing first error message data describing the failed execution of the first test case; and
comparing the first error message data and the flaky test case data, the determining that the first test case is a flaky test case also being based at least in part on the comparing of the first error message data and the flaky test case data.

13. The method of claim 10, the flaky test case data describing a plurality of function calls made by the software application during execution of the at least one flaky test case, the determining that the first test case is a flaky test case comprising determining that a number of common function calls described by both the first stack trace data and the flaky test case data meets a threshold.

14. The method of claim 10, the flaky test case data describing a plurality of function calls made by the software application during execution of the at least one flaky test case, the determining that the first test case is a flaky test case comprising determining that the plurality of function calls made by the software application during the failed execution of the first test case were also made by a threshold number of the at least one flaky test case.

15. The method of claim 10, the determining that the first test case is a flaky test case further comprising determining that a threshold number of error messages described by first error message data describing the failed execution of the first test case match at least one error message described by the flaky test case data.

16. The method of claim 10, further comprising, before the comparing, filtering the first stack trace data to remove at least a portion of the plurality of function calls.

17. The method of claim 16, the at least a portion of the plurality of function calls comprising at least one function call not associated with the first test case.

18. The method of claim 10, further comprising, before the comparing, removing at least a portion of numerical values of the first stack trace data.

19. A non-transitory machine-readable medium comprising instructions thereon that, when executed by at least one processor, because the at least one processor to perform operations:
accessing first stack trace data, the first stack trace data describing a plurality of function calls made by a software application during a failed execution of a first test case;
comparing the first stack trace data and flaky test case data, the flaky test case data describing at least one function call made by the software application during execution of at least one flaky test case, the at least one flaky test case comprising a first flaky test case that the software application passed during one execution of the first flaky test case and failed during another execution of the first flaky test case;
based at least in part on the comparing, determining that the first test case is a flaky test case; and
providing, to a user, an indication that the first test case is a flaky test case.

20. The non-transitory machine-readable medium of claim 19, further comprising:
accessing second stack trace data, the second stack trace data describing a plurality of function calls made by the software application during a failed execution of a second test case;
comparing the second stack trace data to flaky test case data;
determining that the comparing does not indicate that the second test case is a flaky test case;
performing a set of additional executions of the second test case;
determining that the software application passed at least one of the set of additional executions of the second test case; and
updating the flaky test case data based at least in part on the second stack trace data.
